(19) United States
(12) Patent Application Publication
(10) Pub. No.: US 2026/0061401 A1
(43) Pub. Date: Mar. 5, 2026

(54) PREPARATION METHOD OF COMPOSITE CATALYTIC MATERIAL FOR DEGRADING MICROPLASTICS IN WATER

(71) Applicant: Beijing Municipal Research Institute of Eco-Environmental Protection, Beijing (CN)

(72) Inventor: Yuanyuan Shi, Beijing (CN)

(21) Appl. No.: 19/315,685

(22) Filed: Sep. 1, 2025

(30) Foreign Application Priority Data
Sep. 5, 2024 (CN) 2024112433303

(51) Int. Cl. B01J 23/83; B01J 21/18; B01J 37/00; B01J 37/02; B01J 37/03; B01J 37/04; B01J 37/08; C02F 1/72; C02F 101/30

(52) U.S. Cl. CPC B01J 23/83; B01J 21/18; B01J 37/0036; B01J 37/0236; B01J 37/035; B01J 37/04; B01J 37/088; C02F 1/725; C02F 2101/30

(57) ABSTRACT

A preparation method of a composite catalytic material for degrading microplastics in water is provided, which relates to the field of water processing technologies. The method includes: S1, cleaning, drying, pulverizing and sieving walnut shells sequentially in that order; S2, adding sieved walnut shell powder into a mixed solution containing Co(NO₃)₂·6H₂O, La(NO₃)₃·6H₂O and citric acid, stirring it at room temperature, adjusting a pH of the stirred solution with ammonia water until lanthanum cobaltate precipitates on surfaces of walnut shell powder particles, and heating it in a water bath until water evaporates completely; S3, drying and grinding the mixture obtained from coprecipitation in sequence, and performing pyrolysis treatment to obtain a lanthanum cobaltate biochar-based composite catalytic material. The prepared composite catalytic material is simple in preparation process, has a function of efficiently activating peroxymonosulfate, and has a good degradation effect on microplastics in water.

### CROSS-REFERENCE TO RELATED APPLICATION

This application claims priority to Chinese Patent Application No. 202411243330.3, filed on Sep. 5, 2024, which is herein incorporated by reference in its entirety.

### TECHNICAL FIELD

The disclosure relates to the field of water processing technologies, and more particularly to a preparation method of a composite catalytic material for degrading microplastics in water, and the composite catalytic material is a lanthanum cobaltate biochar-based composite catalytic material.

### BACKGROUND

Microplastics generally refer to plastic fragments, particles and fibers with a particle size of less than 5 millimeters (mm). Microplastics have been detected to be widely present in water bodies. Since the microplastics have a small size and a large specific surface area, and are difficult to be degraded, they pose a potential threat to aquatic life and human health. The microplastics are an emerging pollutant, which not only contain toxic substances themselves, but also absorb other pollutants such as heavy metals, antibiotics, and persistent organic matter, thereby forming more complex and more biologically toxic composite pollutants. Therefore, the pollution control technology of the microplastics in water environments has become a new focus in the environmental field.

At present, treatment methods for the microplastics in water mainly include physical methods, biological methods, and advanced oxidation methods. The physical methods such as coagulation and filtration cannot fundamentally degrade the microplastics and cannot achieve complete removal of the microplastics. The biological methods have advantages of low cost and environmental friendliness, but the biodegradation of the microplastics has problems such as long cycle and low efficiency. The advanced oxidation methods have a good degradation effect on the microplastics and are considered to be a very promising way to treat the microplastics. Among them, peroxymonosulfate can be activated by catalytic materials to produce sulfate radicals, which has advantages of thorough degradation, fast reaction rate, and wide range of water quality applications. However, when the current metal-based, carbon-based and other catalytic materials are used as peroxymonosulfate activators, there are problems such as poor catalyst activity, agglomeration of nano-metal particles, and difficulty in solid-liquid separation in water treatment. Therefore, it is necessary to develop catalytic materials that can effectively activate peroxymonosulfate to achieve its efficient degradation of the microplastics in water.

Biomass raw materials are one of the main factors that determine physical and chemical properties of biochar. Biomass is usually composed of lignin, cellulose and hemicellulose. The cellulose and the hemicellulose are more likely to produce volatile gases such as hydrogen (H₂), carbon dioxide (CO₂), and methane (CH₄) during a carbonization process. The pyrolysis of lignin mainly produces residual biochar. The proportions of the lignin, the cellulose and the hemicellulose in different biomasses are different, and the pore structure of biochar after pyrolysis is different.

In addition, it is reported that although some walnut shells are processed and utilized as agricultural and sideline products, a large amount of walnut shells are still not properly treated as waste, and some areas even burn them as fuel, which seriously threatens the quality of the air environment. Since walnut shell charcoal contains more lignin, a yield of biochar produced after pyrolysis of the walnut shells is higher, and the surface of the walnut shells has a large number of active sites. Therefore, the disclosure uses the walnut shells as carriers to prepare lanthanum cobaltate-biochar and use it for microplastic degradation, which provides a theoretical reference for the sustainable utilization of agricultural residues and the large-scale preparation of cheap and efficient biomass-based catalysts.

### SUMMARY

A technical problem to be solved of the disclosure is to provide a preparation method of a composite catalytic material for degrading microplastics in water, so as to solve the problem that the existing catalytic materials have poor degradation effect on microplastics.

In order to solve the above technical problem, the disclosure provides the following technical solution.

A preparation method of a composite catalytic material for degrading microplastics in water including the following steps S1 to S3.

In step S1, walnut shells are sequentially cleaned, dried, pulverized and sieved in that order to obtain sieved walnut shell powder.

In an embodiment, when cleaning the walnut shells, deionized water is used to clean the walnut shells 2-3 times.

In an embodiment, when drying the cleaned walnut shells, the cleaned walnut shells are placed in a constant temperature drying oven, and dried at 60 Celsius degrees (° C.) to 80° C. for 6 hours (h) to 8 h.

In an embodiment, when sieving the walnut shell powder, a particle size is set as 60 mesh.

In step S2, the sieved walnut shell powder is added into a mixed solution containing cobaltous nitrate hexahydrate (Co(NO₃)₂·6H₂O), lanthanum nitrate hydrate (La(NO₃)₃·6H₂O) and citric acid. The mixed solution added with the sieved walnut shell powder is stirred at room temperature to obtain a stirred solution. A pH of the stirred solution is adjusted with ammonia water until lanthanum cobaltate precipitates on surfaces of walnut shell powder particles to obtain a pH-adjusted solution. The pH-adjusted solution is heated in a water bath until water in the pH-adjusted solution evaporates completely to obtain a mixture.

Concentrations of the cobaltous nitrate hexahydrate, the lanthanum nitrate hydrate and the citric acid in the mixed solution are 30 millimoles per liter (mmol/L) to 40 mmol/L, 30 mmol/L to 40 mmol/L, and 35 mmol/L, respectively.

In an embodiment, a ratio between a weight of the sieved walnut shell powder to a volume of the mixed solution is in a range of 30 grams per liter (g/L) to 60 g/L.

In an embodiment, a period of the stirring at the room temperature is in a range of 20 minutes (min) to 60 min.

In an embodiment, the pH of the stirred solution is adjusted to 7-9 with the ammonia water, the pH-adjusted solution is stirred for 20 min to 40 min until a color of the pH-adjusted solution has no significant change, to thereby determine that the lanthanum cobaltate precipitates completely. The pH has a significant effect on the phase composition and micromorphology of lanthanum cobaltate. When the pH of the precursor solution (i.e., the stirred solution) is adjusted to about 5, precipitation begins to occur. When the pH of the precursor solution is too low, no obvious precipitation is produced, the product lanthanum cobaltate crystals are not fully developed, and obvious agglomeration will occur, and the particle size is uneven. In a solution with a pH of 7-9, lanthanum cobaltate has the highest crystallinity, and the product is a fluffy and porous honeycomb structure. When the pH is too high, the product is mainly amorphous, and the structure tends to be dense.

In step S3, the mixture obtained from coprecipitation is dried and ground in sequence to obtain a ground mixture, and pyrolysis treatment is performed on the ground mixture to obtain a lanthanum cobaltate biochar-based composite catalytic material.

In an embodiment, a heating rate of the pyrolysis treatment is in a range of 3 Celsius degrees per minute (° C./min) to 5° C./min, a temperature of the pyrolysis treatment is in a range of 600° C. to 800° C., and a period of the pyrolysis treatment is in a range of 2 h to 4 h.

In an embodiment, during the pyrolysis treatment, high-purity nitrogen is used as protective gas.

The disclosure further provides the lanthanum cobaltate biochar-based composite catalytic material prepared by the method.

The disclosure further provides an application method of the lanthanum cobaltate biochar-based composite catalytic material in catalytic degradation of microplastics in water, including:
adding a lanthanum cobaltate biochar-based composite catalytic material and potassium peroxymonosulfate to water to be treated to degrade microplastics in the water to be treated.

In an embodiment, the lanthanum cobaltate biochar-based composite catalyst material is added in an amount of 0.4 grams (g) to 1 g per gram of the microplastics. The potassium peroxymonosulfate is added in an amount of 6 millimoles per liter (mM) to 10 mM per gram of the lanthanum cobaltate biochar-based composite catalyst material.

Compared with the related art, the disclosure at least has the following beneficial effects.
(1) In the above solution, the coprecipitation-pyrolysis method is used to prepare the lanthanum cobaltate biochar-based composite catalytic material, and the lanthanum cobaltate is coated on the surface of the biochar material by an in-situ growth synthesis method, which can avoid the phenomenon of lanthanum cobaltate agglomeration and cobalt dissolution. At the same time, the obtained lanthanum cobaltate biochar-based composite catalytic material has strong magnetism, which is conducive to rapid solid-liquid separation and easy recovery when used in water treatment.
(2) The lanthanum cobaltate precipitate formed by coprecipitation is an oxide with a typical perovskite structure and has the ability to efficiently activate peroxymonosulfate. The biochar formed by pyrolysis has the advantages of high conductivity, porous structure, and large specific surface area, that is, it can act as a catalyst and a carrier of the lanthanum cobaltate, which assists the Co²⁺/Co³⁺ cycle, thereby realizing the efficient synergistic “adsorption-oxidation” effect of the composite catalytic material and improving the catalytic activity of the composite catalytic material. The lanthanum cobaltate biochar-based composite catalytic material can achieve efficient activation of the peroxymonosulfate and rapid degradation of microplastics in water, greatly improving the treatment efficiency.
(3) The preparation method of the lanthanum cobaltate biochar-based composite catalytic material provided by the disclosure is sample, which mainly performs the coprecipitation reaction through adjusting the pH of the mixed solution, and subsequent pyrolysis treatment. The preparation method does not require complex material preparation equipment, has low requirements for laboratory preparation, and does not produce polluting by-products throughout the process, which conforms to the concept of green preparation. At the same time, the raw material for preparing biochar is solid waste walnut shells, which reduces the cost of catalytic materials and realizes the resource utilization of solid waste.

### BRIEF DESCRIPTION OF DRAWINGS

The drawings, which are incorporated herein and constitute a part of the specification, illustrate embodiments of the disclosure and, together with the description, further serve to explain principles of the disclosure and to enable those skilled in the art to make and use the disclosure.

FIG. 1 illustrates an X-ray diffraction (XRD) characteristic diagram of a lanthanum cobaltate biochar-based composite catalytic material according to an embodiment 2 of the disclosure.

FIG. 2 illustrates a scanning electron microscope (SEM) diagram of the lanthanum cobaltate biochar-based composite catalytic material according to the embodiment 2 of the disclosure.

FIG. 3 illustrates a schematic diagram of degradation rates of microplastics by using composite catalytic materials prepared in embodiments and comparative embodiments.

### DETAILED DESCRIPTION OF EMBODIMENTS

The following is a detailed description of a preparation method of a lanthanum cobaltate biochar-based composite catalytic material for degrading microplastics in water provided by the disclosure in conjunction with the drawings and specific embodiments. At the same time, it is explained here that in order to make the embodiments more detailed, the following embodiments are some of the embodiments, and those skilled in the art may also adopt other alternative methods for some known technologies. The drawings are only for a more specific description of the embodiments, and are not intended to specifically limit the disclosure.

It should be noted that the references to “an embodiment”, “embodiment”, “exemplary embodiments”, “some embodiments” and the like in the specification indicate that the embodiments described may include specific features, structures or characteristics, but not each embodiment may include the specific features, structures or characteristics. In addition, when a specific feature, structure or characteristic is described in conjunction with an embodiment, it should be within the knowledge of those skilled in the art to implement such feature, structure or characteristic in conjunction with other embodiments (whether or not explicitly described).

Lanthanum cobaltate is an oxide with a typical perovskite structure and has an ability to efficiently activate peroxymonosulfate. Biochar materials have excellent electronic properties and can act as a catalyst and a carrier of metal compounds, which plays a role in promoting catalysis and improves overall catalytic activity. Both transition metals and carbon-based materials can achieve activation of the peroxymonosulfate. Combining the two activation methods can improve their ability to remove organic pollutants. The lanthanum cobaltate is as a perovskite-type oxide, and has advantages of stable structure and high redox activity. The lanthanum cobaltate can be used as an effective peroxymonosulfate activator and plays a major activation role. Walnut shell-based biochar has advantages of high conductivity, porous structure, and large specific surface area, which can be used as a carrier of the lanthanum cobaltate to reduce its agglomeration.

The disclosure proposes a preparation method of a composite catalytic material for degrading microplastics in water. Based on the preparation method, a lanthanum cobaltate biochar-based composite catalytic material is obtained, so that redox cycle capability of Co³⁺/Co²⁺ is improved, which can achieve synergistic and efficient activation of the peroxymonosulfate by the lanthanum cobaltate and biochar, and can achieve efficient catalytic degradation of microplastics in water.

Preparation steps of the lanthanum cobaltate biochar-based composite catalytic material are as follows.
Step 1, walnut shells are cleaned with deionized water 2-3 times to remove dissolved impurities. Then, the cleaned walnut shells are placed in a constant temperature drying oven and dried at 60° C. to 80° C. for 6 h to 8 h, to thereby obtain the dried walnut shells. The dried walnut shells are pulverized by using a stainless steel crusher to obtain walnut shell powder. The walnut shell powder is sieved with a 60-mesh particle size to obtain sieved walnut shell powder, and the sieved walnut shell powder is placed into a plastic self-sealing bag for later use.
Step 2, 3 g to 6 g of the sieved walnut shell powder is added into 100 milliliters (mL) of mixed solution containing Co(NO₃)₂·6H₂O, La(NO₃)₃·6H₂O and citric acid, and concentrations of the Co(NO₃)₂·6H₂O, the La(NO₃)₃·6H₂O and the citric acid in the mixed solution are 30 mmol/L to 40 mmol/L, 30 mmol/L to 40 mmol/L, and 35 mmol/L, respectively. The mixed solution added with the sieved walnut shell powder is stirred at room temperature for 30 min to obtain a stirred solution. A pH of the stirred solution is adjusted to 7-9 until lanthanum cobaltate precipitates on surfaces of walnut shell powder particles to obtain a pH-adjusted solution. The pH-adjusted solution is heated in a water bath until water in the pH-adjusted solution evaporates completely.
Step 3, the water-evaporated material (i.e., mixture obtained from coprecipitation) is placed in a vacuum tube furnace to perform pyrolysis treatment with a pyrolysis rate of 5° C./min, a temperature of 600° C. to 800° C., and a period of 2 h to 4 h. High-purity nitrogen is introduced during the entire process to keep a vacuum state in the tube furnace. After the pyrolysis is completed, it is cooled to the room temperature to obtain the lanthanum cobaltate biochar-based composite catalytic material.

In the preparation method of the disclosure, the lanthanum cobaltate is loaded on the surface of the biochar material (i.e., walnut shell powder) by an in-situ growth synthesis method, thereby forming the lanthanum cobaltate biochar-based composite catalytic material. The catalytic material prepared based on this method can effectively alleviate agglomeration of the lanthanum cobaltate and cobalt dissolution, which has low cost and simple preparation process. The composite catalytic material obtained by the preparation method has excellent function to activate the peroxymonosulfate, which can achieve efficient degradation of the microplastics in water, and is easy to use. At the same time, the obtained lanthanum cobaltate biochar-based composite catalytic material has strong magnetism, which is conducive to rapid solid-liquid separation and easy recovery.

The disclosure is described below in conjunction with specific embodiments, and the following embodiments are some of the embodiments.

### Embodiment 1

(1) Walnut shells are cleaned with deionized water 2-3 times to remove dissolved impurities. Then, the cleaned walnut shells are placed in the constant temperature drying oven and dried at 60° C. for 8 h, to thereby obtain the dried walnut shells. The dried walnut shells are pulverized by using the stainless steel crusher to obtain walnut shell powder. The walnut shell powder is sieved with a 60-mesh particle size to obtain sieved walnut shell powder, and the sieved walnut shell powder is placed into a plastic self-sealing bag for later use.
(2) 3 g of the sieved walnut shell powder is added into 100 mL of mixed solution containing Co(NO₃)₂·6H₂O, La(NO₃)₃·6H₂O and citric acid, and concentrations of the Co(NO₃)₂·6H₂O, the La(NO₃)₃·6H₂O and the citric acid in the mixed solution are 30 mmol/L, 30 mmol/L, and 35 mmol/L, respectively. The mixed solution added with the sieved walnut shell powder is stirred at room temperature for 30 min to obtain a stirred solution. A pH of the stirred solution is adjusted to 7.0 until lanthanum cobaltate precipitates on surfaces of walnut shell powder particles to obtain a pH-adjusted solution. The pH-adjusted solution is heated in the water bath until water in the pH-adjusted solution evaporates completely.
(3) The water-evaporated material (i.e., mixture obtained from coprecipitation) is placed in the vacuum tube furnace to perform pyrolysis treatment with a pyrolysis rate of 5° C./min, a temperature of 600° C., and a period of 4 h. High-purity nitrogen is introduced during the entire process to keep a vacuum state in the tube furnace. After the pyrolysis is completed, it is cooled to the room temperature to obtain the lanthanum cobaltate biochar-based composite catalytic material.

0.5 g of polystyrene (PS) microplastics are dispersed in 100 mL of deionized water and sonicated for 10 min to make the PS microplastics disperse completely, to thereby obtain a suspension. 0.25 g of the lanthanum cobaltate biochar-based composite catalytic material and 2 mM of potassium peroxymonosulfate are added into the suspension to cause degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by the lanthanum cobaltate biochar-based composite catalytic material activating peroxymonosulfate. It is calculated that under the catalytic action of the lanthanum cobaltate biochar-based composite catalytic material, the degradation rate of the microplastics is 70.66% after 30 h of reaction.

### Embodiment 2

(1) Walnut shells are cleaned with deionized water 2-3 times to remove dissolved impurities. Then, the cleaned walnut shells are placed in the constant temperature drying oven and dried at 70° C. for 7 h, to thereby obtain the dried walnut shells. The dried walnut shells are pulverized by using the stainless steel crusher to obtain walnut shell powder. The walnut shell powder is sieved with a 60-mesh particle size to obtain sieved walnut shell powder, and the sieved walnut shell powder is placed into a plastic self-sealing bag for later use.
(2) 4.5 g of the sieved walnut shell powder is added into 100 mL of mixed solution containing Co(NO₃)₂·6H₂O, La(NO₃)₃·6H₂O and citric acid, and concentrations of the Co(NO₃)₂·6H₂O, the La(NO₃)₃·6H₂O and the citric acid in the mixed solution are 35 mmol/L, 35 mmol/L, and 35 mmol/L, respectively. The mixed solution added with the sieved walnut shell powder is stirred at room temperature for 30 min to obtain a stirred solution. A pH of the stirred solution is adjusted to 8.0 until lanthanum cobaltate precipitates on surfaces of walnut shell powder particles to obtain a pH-adjusted solution. The pH-adjusted solution is heated in the water bath until water in the pH-adjusted solution evaporates completely.
(3) The water-evaporated material is placed in the vacuum tube furnace to perform pyrolysis treatment with a pyrolysis rate of 5° C./min, a temperature of 700° C., and a period of 4 h. High-purity nitrogen is introduced during the entire process to keep a vacuum state in the tube furnace. After the pyrolysis is completed, it is cooled to the room temperature to obtain the lanthanum cobaltate biochar-based composite catalytic material.

0.5 g of PS microplastics are dispersed in 100 mL of deionized water and sonicated for 10 min to make the PS microplastics disperse completely, to thereby obtain a suspension. 0.25 g of the lanthanum cobaltate biochar-based composite catalytic material and 2 mM of potassium peroxymonosulfate are added into the suspension to cause degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by the lanthanum cobaltate biochar-based composite catalytic material activating peroxymonosulfate. It is calculated that under the catalytic action of the lanthanum cobaltate biochar-based composite catalytic material, the degradation rate of the microplastics is 71.41% after 30 h of reaction.

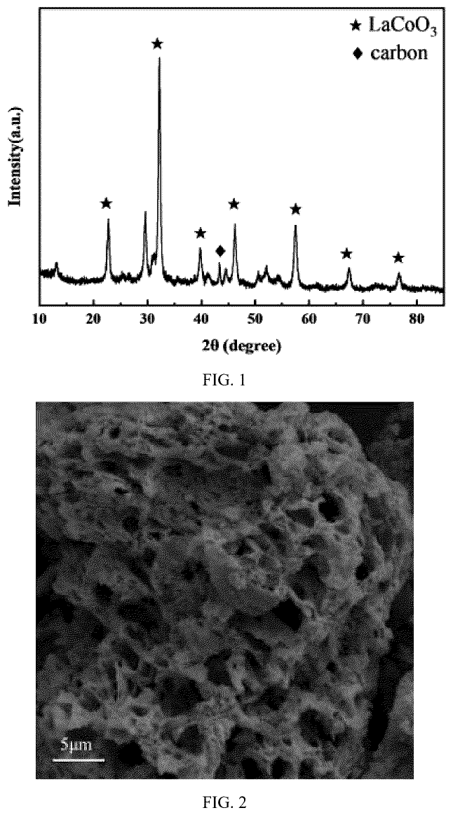

FIG. 1 illustrates an XRD characteristic diagram of a lanthanum cobaltate biochar-based composite catalytic material according to the embodiment 2 of the disclosure, which indicates that the main components of the product are lanthanum cobaltate and carbon, and a crystallinity of the lanthanum cobaltate is very high. FIG. 2 illustrates a SEM diagram of the lanthanum cobaltate biochar-based composite catalytic material according to the embodiment 2 of the disclosure, with a magnification of 1660 times, which indicates that in the obtained composite catalytic material, irregular lanthanum cobaltate nanoparticles are loaded on the porous biochar surface and have abundant active sites. The above test results provide a basis for demonstrating the excellent catalytic performance of the composite catalytic material.

### Embodiment 3

(1) Walnut shells are cleaned with deionized water 2-3 times to remove dissolved impurities. Then, the cleaned walnut shells are placed in the constant temperature drying oven and dried at 80° C. for 7 h, to thereby obtain the dried walnut shells. The dried walnut shells are pulverized by using the stainless steel crusher to obtain walnut shell powder. The walnut shell powder is sieved with a 60-mesh particle size to obtain sieved walnut shell powder, and the sieved walnut shell powder is placed into a plastic self-sealing bag for later use.
(2) 6 g of the sieved walnut shell powder is added into 100 mL of mixed solution containing Co(NO₃)₂·6H₂O, La(NO₃)₃·6H₂O and citric acid, and concentrations of the Co(NO₃)₂·6H₂O, the La(NO₃)₃·6H₂O and the citric acid in the mixed solution are 40 mmol/L, 40 mmol/L, and 35 mmol/L, respectively. The mixed solution added with the sieved walnut shell powder is stirred at room temperature for 30 min to obtain a stirred solution. A pH of the stirred solution is adjusted to 8.5 until lanthanum cobaltate precipitates on surfaces of walnut shell powder particles to obtain a pH-adjusted solution. The pH-adjusted solution is heated in the water bath until water in the pH-adjusted solution evaporates completely.
(3) The water-evaporated material is placed in the vacuum tube furnace to perform pyrolysis treatment with a pyrolysis rate of 5° C./min, a temperature of 800° C., and a period of 4 h. High-purity nitrogen is introduced during the entire process to keep a vacuum state in the tube furnace. After the pyrolysis is completed, it is cooled to the room temperature to obtain the lanthanum cobaltate biochar-based composite catalytic material.

0.5 g of PS microplastics are dispersed in 100 mL of deionized water and sonicated for 10 min to make the PS microplastics disperse completely, to thereby obtain a suspension. 0.25 g of the lanthanum cobaltate biochar-based composite catalytic material and 2 mM of potassium peroxymonosulfate are added into the suspension to cause degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by the lanthanum cobaltate biochar-based composite catalytic material activating peroxymonosulfate. It is calculated that under the catalytic action of the lanthanum cobaltate biochar-based composite catalytic material, the degradation rate of the microplastics is 72.00% after 30 h of reaction.

### Comparative Embodiment 1

0.5 g of PS microplastics are dispersed in 100 mL of deionized water and sonicated for 10 min to make the PS microplastics disperse completely, to thereby obtain a suspension. 2 mM of potassium peroxymonosulfate is added into the suspension to cause oxidative degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by individual peroxymonosulfate. It is calculated that only under the oxidation of peroxymonosulfate, the degradation rate of the microplastics is only 8.22% after 30 h of reaction.

### Comparative Embodiment 2

(1) Wheat straw raw materials are cleaned with deionized water 2-3 times to remove dissolved impurities. Then, the cleaned wheat straw is placed in the constant temperature drying oven and dried at 60° C. for 8 h, to thereby obtain the dried wheat straw. The dried wheat straw is pulverized by using the stainless steel crusher to obtain wheat straw powder. The wheat straw powder is sieved with a 60-mesh particle size to obtain sieved wheat straw powder, and the sieved wheat straw powder is placed into a plastic self-sealing bag for later use.
(2) 3 g of the sieved wheat straw powder is added into 100 mL of mixed solution containing Co(NO₃)₂·6H₂O, La(NO₃)₃·6H₂O and citric acid, and concentrations of the Co(NO₃)₂·6H₂O, the La(NO₃)₃·6H₂O and the citric acid in the mixed solution are 30 mmol/L, 30 mmol/L, and 35 mmol/L, respectively. The mixed solution added with the sieved wheat straw powder is stirred at room temperature for 30 min to obtain a stirred solution. A pH of the stirred solution is adjusted to 7.0 until lanthanum cobaltate precipitates on surfaces of wheat straw powder particles to obtain a pH-adjusted solution. The pH-adjusted solution is heated in the water bath until water in the pH-adjusted solution evaporates completely.
(3) The water-evaporated material is placed in the vacuum tube furnace to perform pyrolysis treatment with a pyrolysis rate of 5° C./min, a temperature of 600° C., and a period of 4 h. High-purity nitrogen is introduced during the entire process to keep a vacuum state in the tube furnace. After the pyrolysis is completed, it is cooled to the room temperature to obtain the lanthanum cobaltate biochar-based (wheat straw) composite catalytic material.

0.5 g of PS microplastics are dispersed in 100 mL of deionized water and sonicated for 10 min to make the PS microplastics disperse completely, to thereby obtain a suspension. 0.25 g of the lanthanum cobaltate biochar-based (wheat straw) composite catalytic material and 2 mM of potassium peroxymonosulfate are added into the suspension to cause degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by the lanthanum cobaltate biochar-based (wheat straw) composite catalytic material activating peroxymonosulfate. It is calculated that under the catalytic action of the lanthanum cobaltate biochar-based (wheat straw) composite catalytic material, the degradation rate of the microplastics is 62.11% after 30 h of reaction.

### Comparative Embodiment 3

(1) Walnut shells are cleaned with deionized water 2-3 times to remove dissolved impurities. Then, the cleaned walnut shells are placed in the constant temperature drying oven and dried at 60° C. for 8 h, to thereby obtain the dried walnut shells. The dried walnut shells are pulverized by using the stainless steel crusher to obtain walnut shell powder. The walnut shell powder is sieved with a 60-mesh particle size to obtain sieved walnut shell powder, and the sieved walnut shell powder is placed into a plastic self-sealing bag for later use.
(2) 3 g of the sieved walnut shell powder is added into 100 mL of mixed solution containing Co(NO₃)₂·6H₂O, ferric nitrate nonahydrate (Fe(NO₃)₃·9H₂O) and citric acid, and concentrations of the Co(NO₃)₂·6H₂O, the Fe(NO₃)₃·9H₂O and the citric acid in the mixed solution are 30 mmol/L, 30 mmol/L, and 35 mmol/L, respectively. The mixed solution added with the sieved walnut shell powder is stirred at room temperature for 30 min to obtain a stirred solution. A pH of the stirred solution is adjusted to 7.0 until lanthanum cobaltate precipitates on surfaces of walnut shell powder particles to obtain a pH-adjusted solution. The pH-adjusted solution is heated in the water bath until water in the pH-adjusted solution evaporates completely.
(3) The water-evaporated material is placed in the vacuum tube furnace to perform pyrolysis treatment with a pyrolysis rate of 5° C./min, a temperature of 600° C., and a period of 4 h. High-purity nitrogen is introduced during the entire process to keep a vacuum state in the tube furnace. After the pyrolysis is completed, it is cooled to the room temperature to obtain a cobalt iron biochar-based composite catalytic material.

0.5 g of PS microplastics are dispersed in 100 mL of deionized water and sonicated for 10 min to make the PS microplastics disperse completely, to thereby obtain a suspension. 0.25 g of the cobalt iron biochar-based composite catalytic material and 2 mM of potassium peroxymonosulfate are added into the suspension to cause degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by the cobalt iron biochar-based composite catalytic material activating peroxymonosulfate. It is calculated that under the catalytic action of the cobalt iron biochar-based composite catalytic material, the degradation rate of the microplastics is 47.82% after 30 h of reaction.

### Comparative Embodiment 4

(1) Walnut shells are cleaned with deionized water 2-3 times to remove dissolved impurities. Then, the cleaned walnut shells are placed in the constant temperature drying oven and dried at 60° C. for 8 h, to thereby obtain the dried walnut shells. The dried walnut shells are pulverized by using the stainless steel crusher to obtain walnut shell powder. The walnut shell powder is sieved with a 60-mesh particle size to obtain sieved walnut shell powder, and the sieved walnut shell powder is placed into a plastic self-sealing bag for later use.
(2) 3 g of the sieved walnut shell powder is added into 100 mL of mixed solution containing Co(NO₃)₂·6H₂O, La(NO₃)₃·6H₂O and citric acid, and concentrations of the Co(NO₃)₂·6H₂O, the La(NO₃)₃·6H₂O and the citric acid in the mixed solution are 30 mmol/L, 30 mmol/L, and 35 mmol/L, respectively. The mixed solution added with the sieved walnut shell powder is stirred at room temperature for 30 min to obtain a stirred solution. A pH of the stirred solution is adjusted to 7.0 until lanthanum cobaltate precipitates on surfaces of walnut shell powder particles to obtain a pH-adjusted solution. The pH-adjusted solution is heated in the water bath until water in the pH-adjusted solution evaporates completely.
(3) The water-evaporated material is placed in the vacuum tube furnace to perform pyrolysis treatment with a pyrolysis rate of 5° C./min, a temperature of 300° C., and a period of 4 h. High-purity nitrogen is introduced during the entire process to keep a vacuum state in the tube furnace. After the pyrolysis is completed, it is cooled to the room temperature to obtain a lanthanum cobaltate biochar-based composite catalytic material.

0.5 g of PS microplastics are dispersed in 100 mL of deionized water and sonicated for 10 min to make the PS microplastics disperse completely, to thereby obtain a suspension. 0.25 g of the lanthanum cobaltate biochar-based composite catalytic material and 2 mM of potassium peroxymonosulfate are added into the suspension to cause degradation reaction to obtain a reacted mixture. After 30 h of reaction, the reacted mixture is centrifuged, and remaining solid material in water is collected and weighed. A weight loss rate of the microplastics is used to represent a degradation rate of the microplastics in water by the lanthanum cobaltate biochar-based composite catalytic material activating peroxymonosulfate. It is calculated that under the catalytic action of the lanthanum cobaltate biochar-based composite catalytic material, the degradation rate of the microplastics is 15.88% after 30 h of reaction.

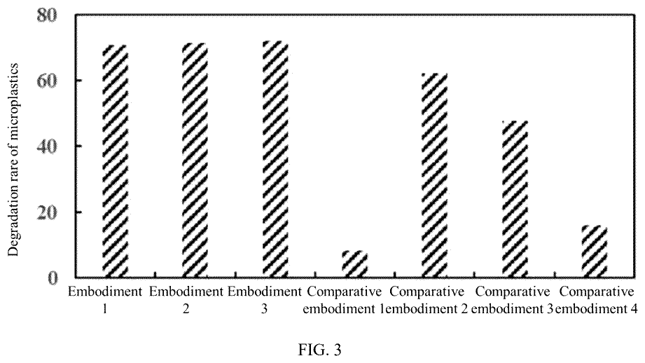

The degradation rates of microplastics in water by of the lanthanum cobaltate biochar-based composite catalytic materials activating peroxymonosulfate of the embodiments 1, 2, and 3 of the disclosure are compared with those of the comparative embodiments 1-4, and a bar graph of the microplastic degradation rates is drawn. The results are shown in FIG. 3.

FIG. 3 shows that through the performance test experiments of the composite catalytic materials in the embodiments 1, 2, and 3, that is, the degradation experiment of microplastics in water treated with potassium peroxymonosulfate activated by the lanthanum cobaltate biochar-based composite catalytic materials, it can be seen that the composite catalytic materials prepared by the method of the disclosure have a degradation rate of more than 70% for microplastics (PS) within 30 h, which shows excellent catalytic degradation performance.

From the experimental results of microplastic degradation in comparative embodiment 1, it can be seen that under the condition of peroxymonosulfate alone, the degradation rate of microplastics within 30 h is only 8.22%, and the removal effect of microplastics is very low.

Compared with the embodiments, the comparative embodiment 2 replaces walnut shells with wheat straw, the comparative embodiment 3 replaces the lanthanum cobaltate with cobalt iron, and the temperature of pyrolysis in the comparative embodiment 4 is too low. The above comparative embodiments show that if the raw materials or reaction conditions are changed, the degradation effect will be significantly affected. It is further verified that the lanthanum cobaltate biochar-based composite catalytic material prepared by the disclosure exhibits excellent performance in activating potassium peroxymonosulfate to degrade microplastics in water.

The above is only specific embodiments of the disclosure, but a protection scope of the disclosure is not limited thereto. Any those skilled in the art can easily think of changes or substitutions within a technical scope disclosed by the disclosure, which should be included in the protection scope of the disclosure. Therefore, the protection scope of the disclosure should be based on the protection scope of the claims.

What is claimed is:

1. An application of a lanthanum cobaltate biochar-based composite catalytic material in catalytic degradation of microplastics in water, wherein a preparation method of the lanthanum cobaltate biochar-based composite catalytic material comprises:
S1, cleaning walnut shells to obtain cleaned walnut shells, drying the cleaned walnut shells to obtain dried walnut shells, pulverizing the dried walnut shells to obtain walnut shell powder, and sieving the walnut shell powder to obtain sieved walnut shell powder;
S2, adding the sieved walnut shell powder into a mixed solution containing cobaltous nitrate hexahydrate (Co(NO₃)₂·6H₂O), lanthanum nitrate hydrate (La(NO₃)₃·6H₂O) and citric acid, stirring the mixed solution added with the sieved walnut shell powder at room temperature to obtain a stirred solution, adjusting a pH of the stirred solution with ammonia water until lanthanum cobaltate precipitates on surfaces of walnut shell powder particles to obtain a pH-adjusted solution, and heating the pH-adjusted solution in a water bath until water in the pH-adjusted solution evaporates completely to obtain a mixture; and
S3, drying and grinding the mixture obtained from coprecipitation in sequence to obtain a ground mixture, and performing pyrolysis treatment on the ground mixture to obtain the lanthanum cobaltate biochar-based composite catalytic material.

2. The application as claimed in claim 1, wherein, in step S1, the cleaning the walnut shells to obtain cleaned walnut shells comprises:
cleaning the walnut shells 2 to 3 times with deionized water to obtain the cleaned walnut shells;
wherein the drying the cleaned walnut shells to obtain dried walnut shells comprises:
placing the cleaned walnut shells in a constant temperature drying oven, and drying the cleaned walnut shells at 60 Celsius degrees (° C.) to 80° C. for 6 hours (h) to 8 h, to obtain the dried walnut shells; and
wherein the sieving the walnut shell powder to obtain sieved walnut shell powder comprises:
sieving the walnut shell powder with a 60-mesh particle size to obtain the sieved walnut shell powder.

3. The application as claimed in claim 1, wherein, in step S2, concentrations of the cobaltous nitrate hexahydrate, the lanthanum nitrate hydrate and the citric acid in the mixed solution are 30 millimoles per liter (mmol/L) to 40 mmol/L, 30 mmol/L to 40 mmol/L, and 35 mmol/L, respectively.

4. The application as claimed in claim 1, wherein, in step S2, a ratio between a weight of the sieved walnut shell powder to a volume of the mixed solution is in a range of 30 grams per liter (g/L) to 60 g/L.

5. The application as claimed in claim 1, wherein, in step S2, a period of the stirring at the room temperature is in a range of 20 minutes (min) to 60 min.

6. The application as claimed in claim 1, wherein, in step S2, the pH of the stirred solution is adjusted to 7-9 with the ammonia water, the pH-adjusted solution is stirred for 20 min to 40 min until a color of the pH-adjusted solution has no significant change, to thereby determine that the lanthanum cobaltate precipitates completely.

7. The application as claimed in claim 1, wherein, in step S3, a heating rate of the pyrolysis treatment is in a range of 3 Celsius degrees per minute (° C./min) to 5° C./min, a temperature of the pyrolysis treatment is in a range of 600° C. to 800° C., and a period of the pyrolysis treatment is in a range of 2 h to 4 h.

8. The application as claimed in claim 1, wherein, in step S3, during the pyrolysis treatment, high-purity nitrogen is used as protective gas.
